(19) United States
(12) Patent Application Publication
(10) Pub. No.: US 2015/0327069 A1
(43) Pub. Date: Nov. 12, 2015

(54) METHOD OF ESTABLISHING WIRELESS CONNECTION AND WIRELESS ACCESS POINT DEVICE

(71) Applicant: ALTEK CORPORATION, Hsinchu (TW)

(72) Inventor: Yen-Sheng FU, Taoyuan County (TW)

(21) Appl. No.: 14/311,792

(22) Filed: Jun. 23, 2014

(30) Foreign Application Priority Data
May 7, 2014 (TW) 103116175
May 7, 2014 (TW) 103116176

(51) Int. Cl. H04W 12/08; H04W 12/06; H04L 29/06

(52) U.S. Cl. CPC H04W 12/08; H04L 63/083; H04W 12/06

(57) ABSTRACT

The present disclosure illustrates a method of establishing wireless connection and a wireless access point device. The method includes: executing a connection establishing program of an electronic device to transmit a connection establishing request to a service program of the wireless access point device; using the service program to transmit audio data containing a network name and a password to the electronic device; receiving and parsing the audio data by an audio receiving unit of the electronic device to obtain the network name and the password; using the connection establishing program to transmit other connection request containing the network name and the password to the service program; permitting the electronic device to log in the wireless access point device according to the network name and the password, to establish the connection between the electronic device and the wireless access point device.

### CROSS-REFERENCE TO RELATED APPLICATION

This application claims the benefit of Taiwan Patent Application No. 103116175, filed on May 7, 2014, in the Taiwan Intellectual Property Office, the disclosure of which is incorporated herein in its entirety by reference.

This application claims the benefit of Taiwan Patent Application No. 103116176, filed on May 7, 2014, in the Taiwan Intellectual Property Office, the disclosure of which is incorporated herein in its entirety by reference.

### BACKGROUND OF THE INVENTION

1. Field of the Invention

The present disclosure relates to a method of establishing connection and a wireless access point device using the same method, in particular, to a method of establishing connection and the wireless access point device capable of transmitting a network name and a password by a wireless approach.

2. Description of the Related Art

At present, the wireless network used in family mainly includes a wireless base which is also called wireless access point. Wireless AP serves as a hub of wireless LAN, and two computers must utilize jumper wire or hub to connect with each other, as the traditional connection in local area network. In addition, if two computers want to connect network at the same time via cable or ADSL, the hub is necessary for connection with internet if the cable modem or ADSL modem does not have multiple RJ-45 interfaces. The wireless access point can be abbreviated as AP, and the wireless LAN can be abbreviated as WLAN.

In using of the wireless AP, in consideration of the security, a mobile device having network transmission module must search a service set identifier of the wireless AP first, and then input a password to log in the wireless AP, the wireless AP establishes the connection between the mobile device and the wireless if the password is correct. However, in traditional way the user must record both of the SSID and password. If the user forget the password, it is hard for user to log in the wireless AP for connecting internet. Moreover, when the users operate a smart phone to connect internet, it is easy for user to input wrong password due to small size of the operational interface of the smart phone. The service set identifier can be abbreviated as SSID.

### SUMMARY OF THE INVENTION

An aspect of exemplary embodiments of the present disclosure directs to a method of establishing connection and a wireless access point device using the same method, so that the user can execute a connection establishing program in an electronic device to connect the wireless access point device without manually inputting password, and the convenience for user to establish connection between the electronic device and the wireless access point device can be improved.

An aspect of exemplary embodiments of the present disclosure directs to a method of establishing connection and a wireless access point device using the same method, whereby the service program of the wireless access point device can be used to transmit high frequency audio to an electronic device, to establish a connection with more privacy and security.

An aspect of exemplary embodiments of the present disclosure directs to a method of establishing connection incorporating Bluetooth and the wireless access point device thereof, whereby the network name and the password of the wireless access point device can be transmitted via the Bluetooth, to replace the traditional way of manual inputting the network name and the password, so as to improve the convenience for user in using the electronic device to connect the wireless access point device.

An exemplary embodiment of the present disclosure provides a method of establishing wireless connection. The method is adapted for wireless connection between an electronic device and a wireless access point device, and includes the following steps: executing a connection establishing program of the electronic device to transmit a connection establishing request to a service program of the wireless access point device; using the service program to transmit audio data containing a network name and a password to the electronic device; receiving and parsing the audio data by an audio receiving unit of the electronic device to obtain the network name and the password; using the connection establishing program to transmit a connection request containing the network name and the password to the service program; permitting the electronic device to log in the wireless access point device according to the network name and the password, to establish the connection between the electronic device and the wireless access point device.

Preferably, the data comprises audio data, and the audio data comprises start frequency, the network name, the password, and stop frequency.

Preferably, the start frequency or/and the stop frequency includes 500 Hz, the interval frequency between the network name and the password includes 500 Hz, the duration between each character of the network name and the password includes 0.5 second.

Preferably, the method further comprises a step before the connection establishing request is transmitted: establishing a Bluetooth connection between a first Bluetooth transmitting unit of the electronic device and a second Bluetooth transmitting unit of the wireless access point device.

Preferably, the service program queries a generic attribute profile to obtain the network name and the password, and the service program transmits the network name and the password to the connection establishing program via the Bluetooth connection.

Preferably, the generic attribute profile comprises the network name, the password, a Wi-Fi access point security type value or a service profile.

Preferably, the Wi-Fi access point security type value comprises WEP (Wireless Encryption Protocol), WPA (Wi-Fi Protected Access) or WPA2 (Wi-Fi Protected Access 2).

Preferably, the first Bluetooth transmitting unit and/or the second Bluetooth transmitting unit comprises a Bluetooth 4.0 having low power consumption.

Preferably, the wireless access point device comprises a cell phone, a camera, a laptop computer, a game player, a printer or a music player which has network transmission function.

Preferably, the service program generates the network name or the password randomly.

An exemplary embodiment of the present disclosure provides a wireless access point device adapted for quickly connecting to an electronic device. The wireless access point device comprises a storage unit, a name and password generating unit, an audio transmitting unit and a connection processing unit. The storage unit stores a character/frequency mapping table. The name and password generating unit generates a network name and a password. The audio transmitting unit transmits audio data containing the network name and the password. The connection processing unit controls the name and password generating unit to generate the network name and the password, and transforms the network name and the password into audio data according to the character and frequency mapping table, and transmits the audio data to the electronic device. The connection processing unit then permits the electronic device to log in the wireless access point device according to a connection request of the electronic device. The connection request comprises the network name and the password.

Preferably, the audio data comprises start frequency, the network name, the password, and the stop frequency.

Preferably, the frequency of the start frequency or the stop frequency includes 500 Hz, the interval frequency between the network name and the password includes 500 Hz, the duration between each character of the network name and the password includes 0.5 second.

Preferably, the wireless access point device comprises a cell phone, a camera, a laptop computer, a game player, a printer or a music player which has network transmission function.

Preferably, the name and password generating unit generates the network name or the password randomly.

An exemplary embodiment of the present disclosure provides a wireless access point device adapted for quickly connecting to an electronic device. The wireless access point device comprises a storage unit, a first Bluetooth transmitting unit and a connection processing unit. The storage unit stores a generic attribute profile which contains a network name and a password. The first Bluetooth transmitting unit establishes a Bluetooth connection with the electronic device, and receives a connection establishing request from the electronic device. The connection processing unit queries the generic attribute profile to obtain the network name and the password according to the connection establishing request, and transmits the network name and the password to the electronic device via the Bluetooth connection. The connection processing unit then permits the electronic device to log in the wireless access point device according to a connection request of the electronic device. The connection request comprises the network name and the password.

Preferably, the generic attribute profile comprises the network name, the password, a Wi-Fi access point security type value or a service profile.

Preferably, the Wi-Fi access point security type value comprises WEP, WPA or WPA2.

Preferably, the wireless access point device comprises a cell phone, a camera, a laptop computer, a game player, a printer or a music player which has network transmission function.

Preferably, the first Bluetooth transmitting unit comprises a Bluetooth 4.0 having low power consumption.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of an exemplary embodiment of a method of establishing connection by using high frequency audio according to the present disclosure.

FIG. 2 is a flow diagram of an exemplary embodiment of method of establishing connection by using high frequency audio according to the present disclosure.

FIG. 3 is a schematic view of other exemplary embodiment of method of establishing connection by using high frequency audio according to the present disclosure.

FIG. 4 is a block diagram of another exemplary embodiment of a wireless access point device according to the present disclosure.

FIG. 5A is a first schematic view of a second exemplary embodiment of method of establishing connection incorporating with Bluetooth according to the present disclosure.

FIG. 5B is a second schematic view of the second exemplary embodiment of method of establishing connection incorporating with the Bluetooth according to the present disclosure.

FIG. 5C is a third schematic view of the second exemplary embodiment of method of establishing connection incorporating with the Bluetooth according to the present disclosure.

FIG. 5D is a fourth schematic view of the second exemplary embodiment of method of establishing connection incorporating with Bluetooth according to the present disclosure.

FIG. 6 is a flow diagram of the second exemplary embodiment of method of establishing connection incorporating with the Bluetooth according to the present disclosure.

FIG. 7 is a schematic view of a third exemplary embodiment of method of establishing connection incorporating with the Bluetooth according to the present disclosure.

FIG. 8 is a block diagram of a fourth embodiment of a wireless access point device according to the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

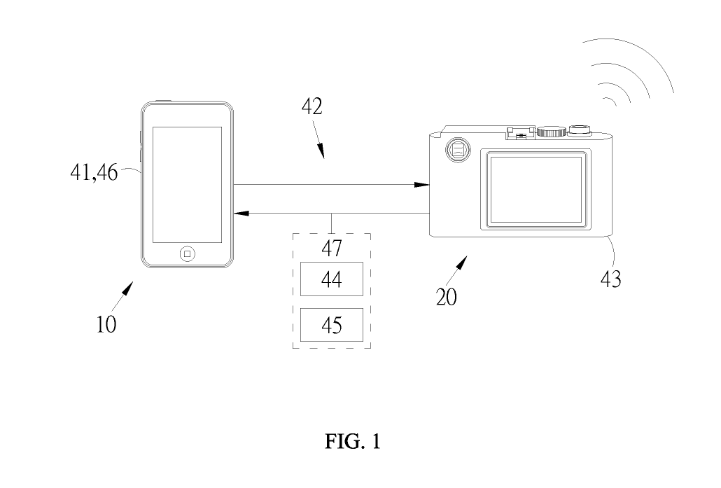

Please refer to FIG. 1 which is a schematic view of an exemplary embodiment of method of establishing connection by using high frequency audio according to the present disclosure. In this exemplary embodiment, a smart phone and a camera are taken as examples for an electronic device 10 and a wireless access point device 20, but the present disclosure is not limited thereto. The electronic device 10 can include a tablet computer, a laptop computer or smart glasses having a microphone. The wireless access point device 20 can include a cell phone, a camera, a laptop computer, a game player, a printer, or music player which has network transmission function.

Before the connection between the electronic device 10 and the wireless access point device 20 is established, the electronic device 10 and the wireless access point device 20 must perform a communication operation for audio data 47. The audio data 47 can be a sound file of high frequency audio, there are two communication approaches including active communication approach and a passive communication approach. In the first communication approach, the wireless access point device 20 active broadcast the audio data 47 containing the network name 44 and the password 45 to the electronic device 10, and the network name 44 or the password 45 can be generated randomly. For implement, a function button of the wireless access point device 20 can be pressed to start to broadcast the audio data 47; or after the wireless access point device 20 is turned on, the audio data 47 is broadcasted automatically.

In the second communication approach, the electronic device 10 and the wireless access point device 20 are installed with a connection establishing program 41 and a service program 43. The connection establishing program 41 and the service program 43 can include a network socket program, and can be executed on the wireless access point device 20 to listen the network packet transmitted by the electronic device 10. After the connection establishing program 41 is executed, the electronic device 10 transmits a connection establishing request 42 to the network via Wi-Fi. While listening to the connection establishing request 42, the service program 43 generates a network name 44 and a password 45, and transforms the network name 44 and the password 45 into audio data 47. In implementation, the password 45 includes an encoded base 64 character. In this exemplary embodiment, the passive communication is taken as example for implementation, but the active communication approach also can be used.

The service program 43 can control a loudspeaker to broadcast the audio of the audio data 47. The audio can include a high frequency audio data, and its frequency is ranged between 1000 Hz and 10000 Hz, and the user can set the frequency for transmitting the audio data 47 to be the frequency audible by human. The electronic device 10 can receive the audio data 47 by an audio receiving unit 46, such as microphone. After parsing the network name 44 and the password 45 from the audio data 47, the connection establishing program 41 of the electronic device 10 transmits a connection request (not shown in FIGs) to the wireless access point device 20 via Wi-Fi. The connection request includes the parsed network name 44 and the parsed password 45. After receiving the connection request, the service program 43 controls the wireless access point device 20 to establish a connection between the electronic device 10 and the wireless access point device 20.

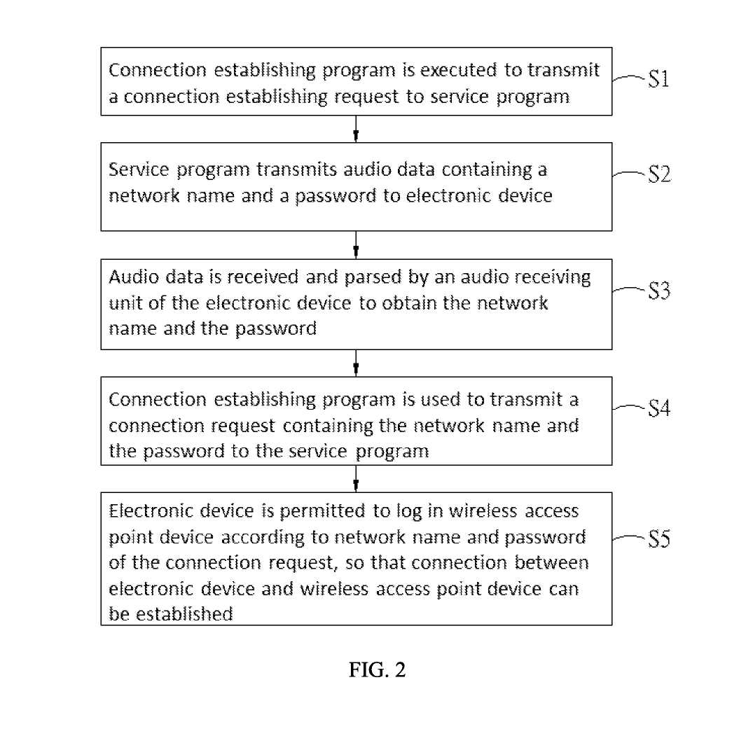

Please refer to FIG. 2 which is a flow diagram of an exemplary embodiment of step method of establishing connection by using high frequency audio according to the present disclosure. In step S1, a connection establishing program of an electronic device is executed to transmit a connection establishing request to a service program of the wireless access point device. In step S2, the service program transmits audio data containing a network name and a password to the electronic device. The audio data can be a high frequency sound file, and the ways of transmitting the sound file can be performed by broadcasting via a loudspeaker. In step S3, the audio data is received and parsed by an audio receiving unit of the electronic device to obtain the network name and the password. In step S4, the connection establishing program is used to transmit a connection request containing the network name and the password to the service program. In step S5, the electronic device is permitted to log in the wireless access point device according to the network name and the password of the connection request, so that the connection between the electronic device and the wireless access point device can be established. The detailed content is the same as the FIG. 1, so the detailed description is omitted.

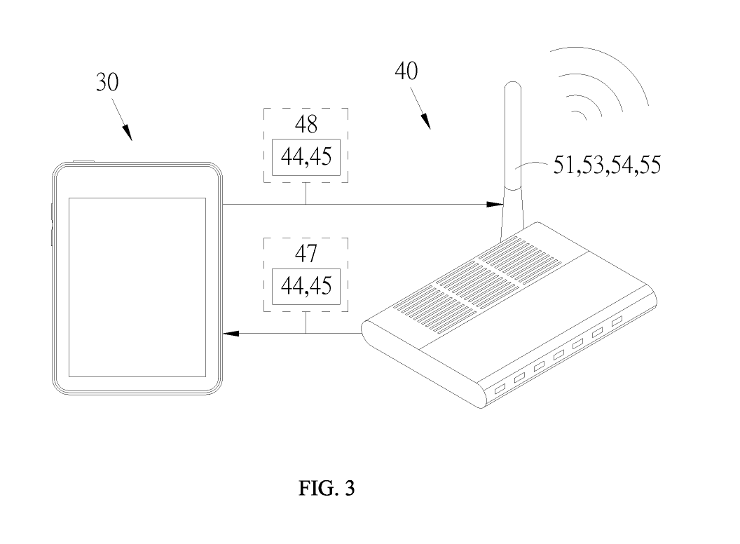

Please refer to FIG. 3 which is a schematic view of other exemplary embodiment of method of establishing connection by using high frequency audio according to the present disclosure. In this exemplary embodiment, a tablet computer and a wireless router are taken as examples for an electronic device 30 and a wireless access point device 40, but the present disclosure is not limited thereto. When the wireless access point device 40 receives a connection establishing request (not shown in FIGs) transmitted by the electronic device 30, the audio transmitting unit 54 transmits audio data 47 containing the network name 44 and the password 45 to an audio receiving unit 46 of the electronic device 30. In implementation, the audio transmitting unit 54 can include a loudspeaker, the audio receiving unit 46 can include a microphone, the audio data 47 can include a sound in short range and high frequency.

After receiving a connection request 48 containing the network name 44 and the password 45 from the electronic device 30, the connection processing unit 55 controls the wireless access point device 40 to establish a connection between the electronic device 30 and the wireless access point device 40.

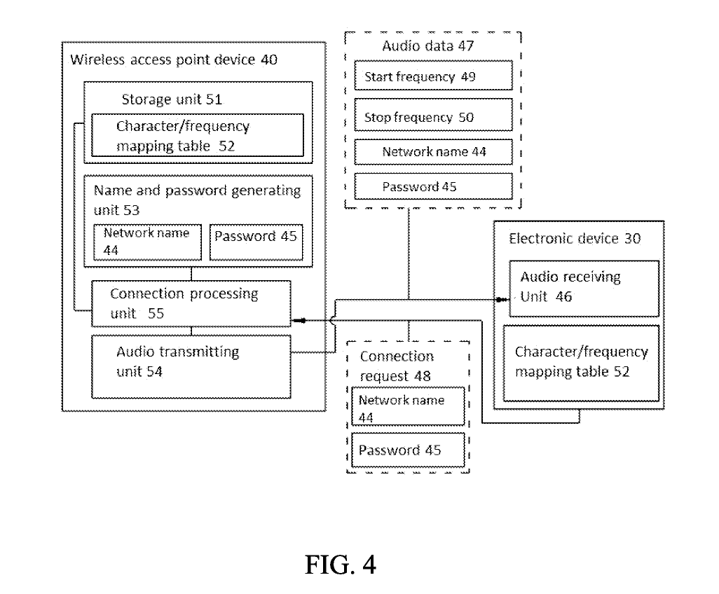

Please refer to FIG. 4 which is a block diagram of another exemplary embodiment of a wireless access point device according to the present disclosure. The wireless access point device is adapted for quickly connecting to an electronic device 30. The wireless access point device 40 includes a storage unit 51, a name and password generating unit 53, an audio transmitting unit 54, and a connection processing unit 55. The storage unit 51 can include a memory, the name and password generating unit 53 can include an application, the audio transmitting unit 54 can include a microphone, and the connection processing unit 55 can include a microprocessor.

The storage unit 51 can store a character/frequency mapping table 52. The name and password generating unit 53 generates a network name 44 and a password 45 randomly. The audio transmitting unit 54 transmits the audio data 47 containing the network name 44 and the password 45. The audio data 47 can be a file of high frequency short range sound data. The connection processing unit controls the name and password generating unit 53 to generate the network name 44 and the password 45, and transforms the network name 44 and the password into audio data 47 according to the character and frequency mapping table 52. The audio transmitting unit 54 then transmits the audio data 47 to the electronic device 30. Next, the connection processing unit 55 permits the electronic device 30 to log in the wireless access point device 40 according to a connection request 48 of the electronic device 30.

In implementation, the audio data 47 includes a start frequency 49, the network name 44, the password 45 and the stop frequency 50. The frequency of the start frequency 49 and/or the stop frequency 50 is 500 Hz, the interval frequency between the network name 44 and the password 45 includes 500 Hz, the duration between each character of the network name 44 and the password 45 includes 0.5 second. For example, if the generated network name 44 and password 45 is “AQR” and “WgA”, according to the character/frequency mapping table 52, the frequency content of the audio data 47 is equal to {<500 Hz>, <1000 Hz>, <1800 Hz>, <1850 Hz>, <500 Hz>, <2100 Hz>, <2600 Hz>, <1000 HZ>, <500 Hz>}, wherein the number inside “< >” indicates the frequency for each character during 0.5 second.

It is noted that the character/frequency mapping table 52 can be stored in the electronic device 30 and the wireless access point device 40 in advance, so that the electronic device 30 can parse the network name 44 and the password 45 from the received audio data 47. By this way, because only the wireless access point device 40 and the electronic device 30 can utilize the character/frequency mapping table 52 to parse the content of the audio data 47, it can ensure that the network name 44 and password 45 is hard to be stolen during the transmitting process from the wireless access point device 40 to the electronic device 30. In addition, the volume of the loudspeaker for broadcasting the audio data 47 can be adjusted appropriately to control the broadcasting range where just the electronic device 30 can receive the audio data 47.

TABLE 1
character/frequency mapping table

| Value | Char | Freq. |
|---|---|---|
| 0 | A | 1000 Hz |
| 1 | B | 1050 Hz |
| 2 | C | 1100 Hz |
| 3 | D | 1150 Hz |
| 4 | E | 1200 Hz |
| 5 | F | 1250 Hz |
| 6 | G | 1300 Hz |
| 7 | H | 1350 Hz |
| 8 | I | 1400 Hz |
| 9 | J | 1450 Hz |
| 10 | K | 1500 Hz |
| 11 | L | 1550 Hz |
| 12 | M | 1600 Hz |
| 13 | N | 1650 Hz |
| 14 | O | 1700 Hz |
| 15 | P | 1750 Hz |
| 16 | Q | 1800 Hz |
| 17 | R | 1850 Hz |
| 18 | S | 1900 Hz |
| 19 | T | 1950 Hz |
| 20 | U | 2000 Hz |
| 21 | V | 2050 Hz |
| 22 | W | 2100 Hz |
| 23 | X | 2150 Hz |
| 24 | Y | 2200 Hz |
| 25 | Z | 2250 Hz |
| 26 | a | 2300 Hz |
| 27 | b | 2350 Hz |
| 28 | c | 2400 Hz |
| 29 | d | 2450 Hz |
| 30 | e | 2500 Hz |
| 31 | f | 2550 Hz |
| 32 | g | 2600 Hz |
| 33 | h | 2650 Hz |
| 34 | i | 2700 Hz |
| 35 | j | 2750 Hz |
| 36 | k | 2800 Hz |
| 37 | l | 2850 Hz |
| 38 | m | 2900 Hz |
| 39 | n | 2950 Hz |
| 40 | o | 3000 Hz |
| 41 | p | 3050 Hz |
| 42 | q | 3100 Hz |
| 43 | r | 3150 Hz |
| 44 | s | 3200 Hz |
| 45 | t | 3250 Hz |
| 46 | u | 3300 Hz |
| 47 | v | 3350 Hz |
| 48 | w | 3400 Hz |
| 49 | x | 3450 Hz |
| 50 | y | 3500 Hz |
| 51 | z | 3550 Hz |
| 52 | 0 | 3600 Hz |
| 53 | 1 | 3650 Hz |
| 54 | 2 | 3700 Hz |
| 55 | 3 | 3750 Hz |
| 56 | 4 | 3800 Hz |
| 57 | 5 | 3850 Hz |
| 58 | 6 | 3900 Hz |
| 59 | 7 | 3950 Hz |
| 60 | 8 | 4000 Hz |
| 61 | 9 | 4050 Hz |
| 62 | + | 4100 Hz |
| 63 | / | 4150 Hz |

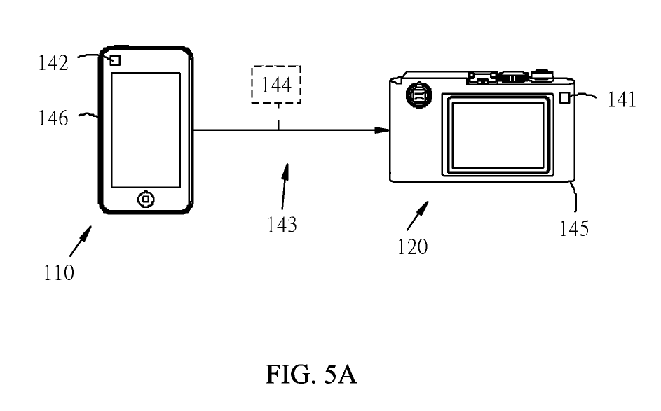

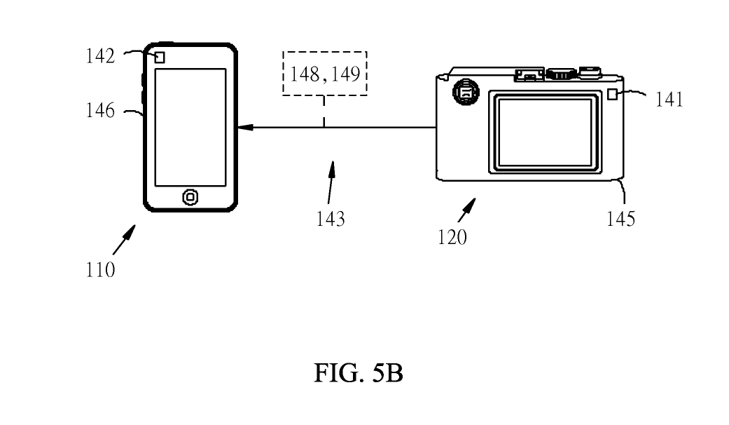

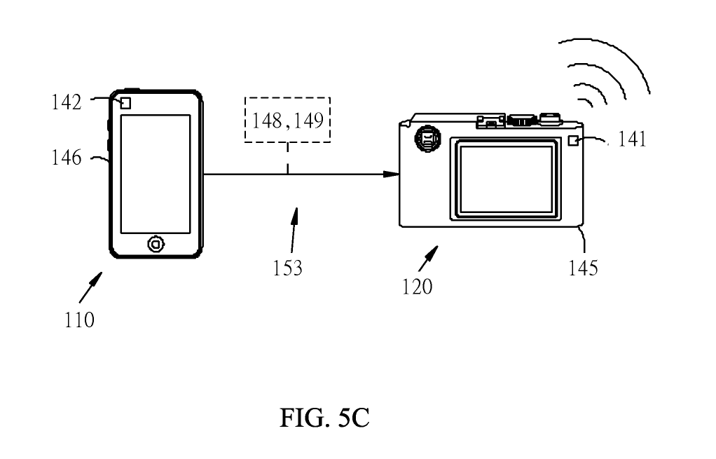

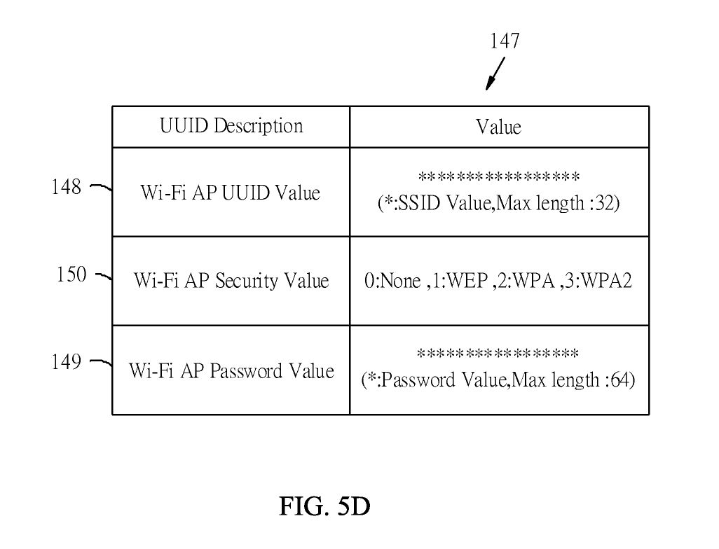

Please refer to FIG. 5A, FIG. 5B, FIG. 5C and FIG. 5D which are first schematic view, second schematic view, third schematic view and fourth schematic view of a second exemplary embodiment of the method of establishing connection incorporating with Bluetooth according to the present disclosure. In this exemplary embodiment, a cell phone and a camera are taken as examples for an electronic device 110 and a wireless access point device 120, but the present disclosure is not limited thereto. The electronic device 110 can include a laptop computer or a tablet computer which has Bluetooth transmission module. The wireless access point device 120 can be a cell phone, a camera, a laptop computer, a game player, a printer or music player which has a Bluetooth transmission module and network transmission module.

As shown FIG. 5A, a connection establishing program 146 and a service program 145 are installed in the electronic device 110 and the wireless access point device 120, respectively, and the service program 145 is executed to display an indication name of a first Bluetooth transmitting unit 141. The first Bluetooth transmitting unit 141 and/or the second Bluetooth transmitting unit 142 can include Bluetooth 4.0 having low power consumption, so the communicating distance between the electronic device 110 and the wireless access point device 120 can be 100 meters without obstacle. The connection establishing program 146 or the service program 145 can be an application.

The connection establishing program 146 is executed to utilize a second Bluetooth transmitting unit 142 to search the first Bluetooth transmitting unit 141. After the indication name of the first Bluetooth transmitting unit 141 is obtained, a connection establishing request 144 for establishing a Bluetooth connection 143 is transmitted to the service program 145. Next, the service program 145 permits the second Bluetooth transmitting unit 142 to establish the Bluetooth connection 143 with the first Bluetooth transmitting unit 141. The connection establishing request 144 can include an identification name of the connection establishing program 146, so that the service program 145 can know the connection establishing request 144 is transmitted from the electronic device 110 installed with the connection establishing program 146.

As shown in FIG. 5B, after the Bluetooth connection 143 is established, the service program 145 queries a generic attribute (GATT) profile 147 stored in the wireless access point device 120. The generic attribute profile 147 contains the network name 148, the password 149, or Wi-Fi access point security type value 150. After obtaining the network name 148 and the password 149 in the generic attribute profile 147, the service program 145 returns the network name 148 and the password 149 to the connection establishing program 146 via Bluetooth connection 143.

As shown in FIG. 5C, the connection establishing program 146 terminates the Bluetooth connection 143 and searches the wireless access point device 120 which matches the network name 148 on the network via Wi-Fi, and then transmit the received password 149 to the service program 145. Next, the service program 145 establishes the network connection between the electronic device 110 and the wireless access point device 120 after verifying the password 149.

In implementation, the network name 148 can be a SSID. The Wi-Fi access point security type value 150 can include a wireless encryption protocol, a Wi-Fi protected access, or Wi-Fi protected access2. The password 149 can include a form of base64 code, and the FIG. 5D displays content of the password 149 in the generic attribute profile 147. The wireless encryption protocol can be abbreviated as WEP, Wi-Fi Protected Access can be abbreviated as WPA, and Wi-Fi protected access 2 can be abbreviated as WAP2.

It is noted that the password 149 in the generic attribute profile 147 can be a random value. In implementation, when the service program 145 receives the connection establishing request 144, the service program 145 calls a random number generating program to generate the password 149, and store the password 149 in the generic attribute profile 147 for being queried by the service program 145. Therefore, it is difficult for the person with high aspirations and determination to steal the password 149 for further performing connection with the wireless access point device 120.

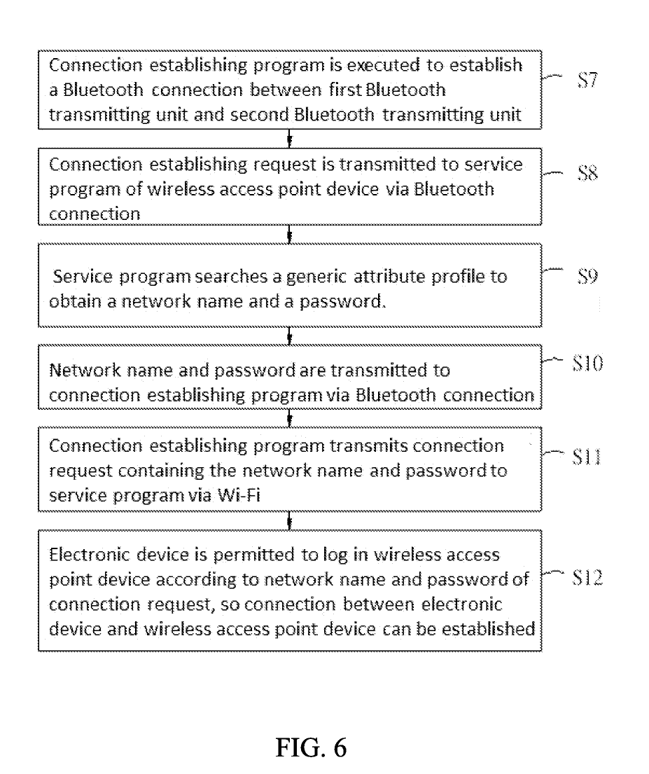

Please refer to FIG. 6 which is a flow diagram of a second exemplary embodiment of the method of establishing connection incorporating with the Bluetooth according to the present disclosure. In step S7, the connection establishing program of the electronic device is executed to establish a Bluetooth connection between a first Bluetooth transmitting unit and a second Bluetooth transmitting unit. In step S8, a connection establishing request is transmitted to a service program of the wireless access point device via Bluetooth connection. The content of the step S7 and the step S8 shown in FIG. 5A is that the Bluetooth connection 143 is established via Bluetooth.

In step S9, the service program queries a generic attribute profile to obtain a network name and a password. The implementation for the generic attribute profile 147 is shown in FIG. 5D. In step S10, the network name and the password are transmitted to the connection establishing program via the Bluetooth connection. In step S11, the connection establishing program transmits a connection request containing the network name and the password to the service program via Wi-Fi. In step S12, the electronic device is permitted to log in the wireless access point device according to the network name and the password of the connection request, so that the connection between the electronic device and the wireless access point device can be established. The implementation for the step S11 and the step S12 are shown in FIG. 5B and FIG. 5C, the electronic device 110 transmits the connection request 153 to the wireless access point device 120, and the wireless access point device 120 is permitted by the service program 145 to establishing connection with the electronic device 110.

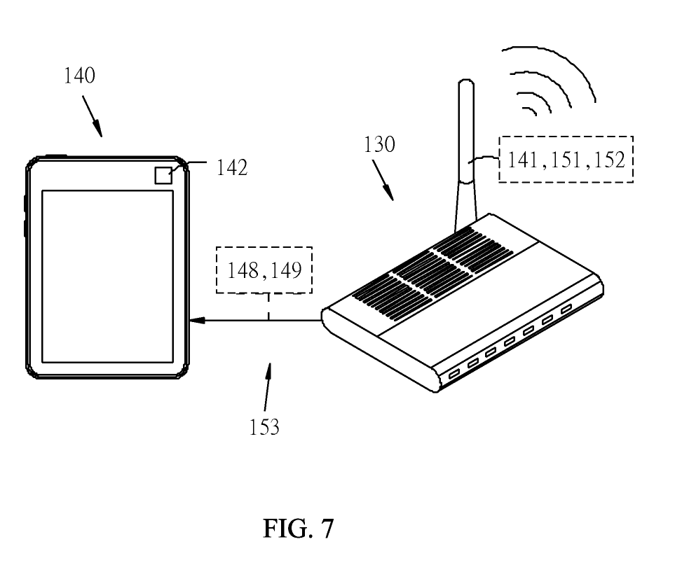

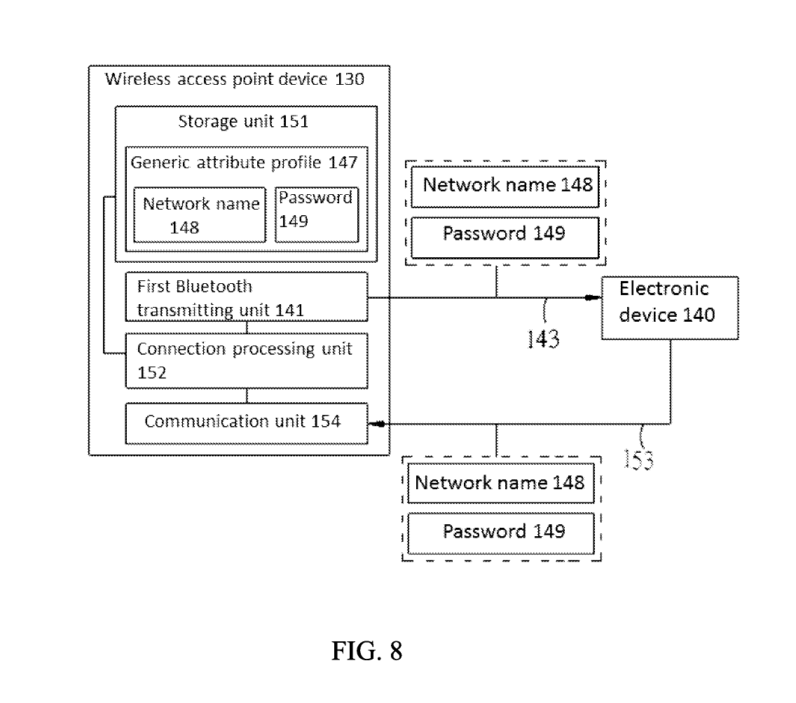

Please refer to FIG. 7 and FIG. 8. FIG. 7 is a schematic view of a third embodiment of a method of establishing connection incorporating with the Bluetooth according to the present disclosure, and FIG. 8 is a block diagram of a fourth embodiment of a wireless access point according to the present disclosure. The wireless access point device 130 is adapted for wirelessly connecting with an electronic device 140. The wireless access point device 130 includes a storage unit 151, a first Bluetooth transmitting unit 141, a connection processing unit 152 and a communication unit 154. The storage unit 151 can be a database, the first Bluetooth transmitting unit 141 may include a Bluetooth 4.0 transmission module having low power consumption, and the connection processing unit 152 may include a microprocessor, the communication unit 154 may include a network transmission module.

The storage unit 151 can store a generic attribute profile 147 which contain a network name 148, the password 149, the Wi-Fi access point security type value (not shown in FIGs) or service profile. The first Bluetooth transmitting unit establishes a Bluetooth connection 143 with a second Bluetooth transmitting unit 142 of the electronic device 140 and receives a connection establishing request (not shown in FIGs) from the electronic device 140. The connection processing unit 152 queries the generic attribute profile 147 to obtain the network name 148 and the password 149 according to the connection establishing request, and returns the network name 148 and the password 149 to the electronic device 140. Next, according to a connection request 153 of the electronic device 110, the connection processing unit 152 permits the electronic device 140 to log in the wireless access point device 130 to perform connection between the wireless access point device 130 and the electronic device 140. The connection request 153 includes the network name 148 of the wireless access point device 130, and the password 149 which is need to log in the wireless access point device 130.

In summary, the method of establishing connection and the wireless access point device using the same method according to the present disclosure provides the user to connect the wireless access point device just by executing the connection establishing program of the electronic device and without manually inputting the one-time password, so that the convenience for user to establish connection between the electronic device and the wireless access point device is improved. In addition, in the structure of the service program and the connection establishing program, the way of transmitting the audio data containing the network name and the password can efficiently decrease the risk of password being stolen. In addition, the electronic device of the present disclosure can receive the network name and the password of the wireless access point device via the Bluetooth first, and then transmits the network name and the password to the wireless access point device for connection between the wireless access point device and the electronic device, so that the convenience for user to connect the electronic device and the wireless access point device is improved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of establishing wireless connection, adapted for wireless connection between an electronic device and a wireless access point device, the method comprising:
executing a connection establishing program of the electronic device to transmit a connection establishing request to a service program of the wireless access point device;
using the service program to transmit data containing a network name and a password to electronic device;
receiving and parsing the data by the electronic device, to obtain the network name and the password;
using the connection establishing program to transmit a connection request to the service program, the connection request containing the network name and the password; and
permitting the electronic device to log in the wireless access point device according to the network name and the password, to establish the connection between the electronic device and the wireless access point device.

2. The method as defined in claim 1, wherein the data comprises audio data, and the audio data comprises a start frequency, the network name, the password and a stop frequency.

3. The method as defined in claim 2, wherein the start frequency and/or the stop frequency includes 500 Hz, an interval frequency between the network name and the password includes 500 Hz, and duration between each character of the network name and the password includes 0.5 seconds.

4. The method as defined in claim 1, further comprising, before the connection establishing request is transmitted, establishing a Bluetooth connection between a first Bluetooth transmitting unit of the electronic device and a second Bluetooth transmitting unit of the wireless access point device.

5. The method as defined in claim 4, wherein the service program queries a generic attribute (GATT) profile to obtain the network name and the password, and the service program transmits the data containing the network name and the password to the connection establishing program via the Bluetooth connection.

6. The method as defined in claim 5, wherein the generic attribute profile comprises the network name, the password, a Wi-Fi access point security type value or a service profile.

7. The method as defined in claim 6, wherein the Wi-Fi access point security type value comprise WEP, WPA or WPA2.

8. The method as defined in claim 4, wherein the first Bluetooth transmitting unit and/or the second Bluetooth transmitting unit comprises a Bluetooth 4.0 having low power consumption.

9. The method as defined in claim 1, wherein the wireless access point device comprises a cell phone, a camera, a laptop computer, a game player, a printer, or a music player which has network transmission function.

10. The method as defined in claim 1, wherein the service program generates the network name or the password randomly.

11. A wireless access point device, adapted for quickly connecting to an electronic device, and the wireless access point device comprising:
a storage unit, adapted to store a character/frequency mapping table;
a name and password generating unit, adapted to generate a network name and a password;
an audio transmitting unit, adapted to transmit audio data containing the network name and the password; and
a connection processing unit, adapted to control the name and password generating unit to generate the network name and the password, and transform the network name and the password into audio data according to the character/frequency mapping table, and transmit the audio data to the electronic device, wherein the connection processing unit permits the electronic device to log in the wireless access point device according to a connection request of the electronic device which comprises the network name and the password.

12. The wireless access point device as defined in claim 11, wherein the audio data comprise a start frequency, the network name, the password and a stop frequency data.

13. The wireless access point device as defined in claim 12, wherein the frequency of the start frequency or the stop frequency includes 500 Hz, the interval frequency between the network name and the password includes 500 Hz, duration between each character of the network name and the password includes 0.5 second.

14. The wireless access point device as defined in claim 11, wherein the wireless access point device comprises a cell phone, a camera, a laptop computer, a game player, a printer, or a music player which has network transmission function.

15. The wireless access point device as defined in claim 11, wherein the name and password generating unit generates the network name or the password randomly.

16. A wireless access point device, adapted for quickly connecting to an electronic device, and the wireless access point device comprising:
a storage unit, adapted to store a generic attribute profile which contains a network name and a password;
a first Bluetooth transmitting unit, adapted to establish a Bluetooth connection with the electronic device, and receive a connection establishing request of the electronic device; and
a connection processing unit, adapted to query the generic attribute profile to obtain the network name and the password according to the connection establishing request, and transmit the network name and the password to the electronic device via the Bluetooth connection, wherein the connection processing unit permits the electronic device to log in the wireless access point device according to a connection request of the electronic device;
wherein the connection request comprises the network name and the password.

17. The wireless access point device as defined in claim 16, wherein the generic attribute profile comprises the network name, the password, a Wi-Fi access point security type value or a service profile.

18. The wireless access point device as defined in claim 17, wherein the Wi-Fi access point security type value comprises WEP, WPA or WPA2.

19. The wireless access point device as defined in claim 16, wherein the wireless access point device comprises a cell phone, a camera, a laptop computer, a game player, a printer, or a music player which has network transmission function.

20. The wireless access point device as defined in claim 16, wherein the first Bluetooth transmitting unit comprises a Bluetooth 4.0 having low power consumption.
